(19) United States
(12) Patent Application Publication
(10) Pub. No.: US 2024/0290168 A1
(43) Pub. Date: Aug. 29, 2024

(54) DIGITAL PLATFORM FOR AUTOMATED CONTENT GENERATION

(71) Applicant: OddsJam, Inc., Falls Church, VA (US)

(72) Inventors: Ankit Goyal, Falls Church, VA (US); Alexander David Monahan, Falls Church, VA (US)

(73) Assignee: OddsJam, Inc., Falls Church, VA (US)

(21) Appl. No.: 18/585,144

(22) Filed: Feb. 23, 2024

Related U.S. Application Data
(60) Provisional application No. 63/447,913, filed on Feb. 24, 2023.

(51) Int. Cl. G07F 17/32; G06Q 50/34

(52) U.S. Cl. CPC G07F 17/323; G06Q 50/34; G07F 17/3288

(57) ABSTRACT

Disclosed embodiments provide techniques for a digital platform for automated content generation. One or more digital betting platforms are accessed. The digital betting platforms each provide one or more betting odds opportunities for online users, including odds opportunities for sporting events. The sporting events data is cross-validated with content from other websites to confirm that sporting events are active. A content trigger event corresponding to at least one of the betting odds opportunities is detected. Data from the betting opportunities is aggregated, and the data is used to generate a human-readable online article. The aggregated data is used to select one or more dynamic article features related to the betting odds opportunities. The dynamic article features are used as part of the human-readable online article. The online article is published and refreshed on a fixed-time cadence.

### RELATED APPLICATIONS

This application claims the benefit of U.S. provisional patent application “Digital Platform For Automated Content Generation” Ser. No. 63/447,913, filed Feb. 24, 2023.

The foregoing application is hereby incorporated by reference in its entirety.

### FIELD OF ART

This application relates generally to content generation and more particularly to a digital platform for automated content generation.

### BACKGROUND

Gambling has been a recreational activity in many cultures for centuries. Six-sided dice have been uncovered in Mesopotamian archaeological digs dating to about 3,000 BC. The dice were based on throwing sticks or bones used as a part of games and fortune telling thousands of years earlier. Gambling houses became widespread in China in the first millennia BC. Betting on fighting animals was common. Playing card games appeared in the 9^{th} century AD in China, with the ancestor of the game of poker arising in Persia in the 17^{th} century AD. As gambling became more and more popular, governments began to control or in some cases ban at least some forms of it. The natural outcome of such legislation was tourism to areas where gambling was legal and participation in illegal gambling where it was not. Many jurisdictions limit the age of participants. Jurisdictions may also require that gambling devices be statistically random to prevent high-payoff results being made impossible. Most world religions discourage gambling. Buddhism, Hinduism, and Judaism believe that gambling has a destructive impact on individuals and society at large. Catholic and Protestant churches believe that gambling is a sin that feeds on greed. Islam condemns gambling as sin and declares it punishable by up to twelve lashes or a one-year prison term. Even so, gambling and betting remain popular worldwide.

There are many forms of gambling. Table games of chance such as blackjack, craps, roulette, and baccarat are often found in casinos and gambling houses across the world. Casinos also routinely offer gaming machines including pachinko, slot machines, video lottery, and video poker. Casinos and many other gaming establishments also offer random number games such as bingo and keno. Many casino games give a long-term advantage to the casino or the “house”. The player typically is offered a short-term gain that can be large. However, the casino does not offer payouts that reflect the true odds of the game being played. For instance, a game played using one six-sided die may only pay four times the amount wagered for a winning bet, when the true odds would be six times the betted amount. Different games in a gambling house will have different levels of house advantage. Some house advantages can be as high as 25 percent of the players' bets, while others can be as low as 0.3 percent. Even when games are not competing against the house, but instead against one another, the gambling house earns a commission, usually based on the amount of the total amount of money being put at risk.

There are many forms of gambling outside of a casino as well. Carnival games, coin-tossing games, dice games, card games, lotteries, and so on are all played in many different settings, including homes, taverns, and town halls. Fixed-odds betting is available for all sorts of events, including political elections, television competitions, horse racing, and so on. Given its continued popularity and the financial incentives for both the gambling industry and players, gambling, in all of its many forms, is sure to be with us for many, many years to come.

### SUMMARY

Techniques describing a digital platform for automated content generation are described. Digital betting platforms are available via the Internet for online bettors and oddsmakers. There are many forms of betting available and many types of contests, events, and sports on which to place wagers. The betting platforms vary widely, but generally display games and contests on which a bettor can place a wager, along with schedule and location information, details on the players, etc. Online gambling is a worldwide enterprise, with websites being hosted in many different locations. This gives the bettor a broad range of opportunities for placing wagers. In many cases, there can be several different betting platforms quoting odds and accepting wagers on the same game or contest. The differences in the platforms can be quite subtle and the bettor is well advised to take a “buyer beware” attitude toward the websites so that the variances are clearly understood. The differences can include the odds on the game itself; the manner in which the odds are quoted; the fee (vigorish) charged by the site; abbreviations of names, times, dates, locations; and so on. These differences can make it challenging for a bettor to compare one betting platform to another.

Disclosed embodiments provide techniques for a digital platform for automated content generation. One or more digital betting platforms are accessed. The digital betting platforms each provide one or more betting odds opportunities for online users, including odds opportunities for sporting events. The sporting event data is cross-validated with content from other websites to confirm that sporting events are active. A content trigger event corresponding to at least one of the betting odds opportunities is detected. Data from the betting opportunities is aggregated, and the data is used to generate a human-readable online article. The aggregated data is used to select one or more dynamic article features related to the betting odds opportunities. The dynamic article features are used as part of the human-readable online article. The online article is published and refreshed on a fixed-time cadence.

A computer-implemented method for content generation is disclosed comprising: accessing one or more digital betting platforms, wherein the one or more digital betting platforms each provide one or more betting odds opportunities for an online user, and wherein the one or more betting odds opportunities include sporting events; detecting a content trigger event, wherein the content trigger event corresponds to at least one of the one or more betting odds opportunities; aggregating data from the at least one of the one or more betting odds opportunities, wherein the data enables generating a human-readable online article; selecting one or more dynamic article features related to the at least one of the one or more betting odds opportunities; and publishing the online article, wherein the online article includes the at least one of the one or more betting odds opportunities and the one or more dynamic article features. Some embodiments comprise cross-validating a sporting event, based on the detecting. In embodiments, the cross-validating includes an automatic website lookup. In embodiments, the cross-validating confirms that the sporting event is active. Some embodiments comprise using a random number generator to initiate the publishing.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for digital platform automatic content generation.

FIG. 2 is a flow diagram for publishing automated content.

FIG. 3 is a block diagram for a digital platform for automated content generation.

FIG. 4 is a first example of a template.

FIG. 5 is a second example of a template.

FIG. 6 illustrates a digital platform user interface.

FIG. 7 is a table showing sports betting opportunities.

FIG. 8 is a system diagram for a digital platform for automated content generation.

### DETAILED DESCRIPTION

Gambling, especially online betting, has become increasingly popular and profitable over the past several years. Online betting platforms are available worldwide with opportunities to place wagers on sporting events, political contests, and occurrences of all sorts. Wagers can be placed on nearly every kind of sports contest, including horse and greyhound races, dirt bike races, ping-pong matches, professional sports games, and so on. Bets can be made in advance of the contest or even during the event itself on instances such as which team will score first, what player will run the fastest leg of a relay, which dive will be chosen as the last by a particular competitor, etc. With so many betting platforms and betting opportunities, a bettor can always find something on which to place a wager.

Online betting platforms vary widely in the ways in which odds are stated, and the ways in which teams, individual competitors, schedules, and locations are listed. Along with the differences in notations, the odds on the same sports contest can vary from one betting site to the next. Different oddsmakers can come to different conclusions on the most likely outcome of a contest. In some cases, these odds differences can provide an additional betting opportunity to a bettor. Arbitrage betting is a method of placing bets on all possible outcomes of a sporting contest so that the bettor is guaranteed a profit. It requires the bettor to find odds discrepancies between betting platforms on the same contest and to place their wagers on the various betting platforms correctly in order to secure a profit. In most arbitrage instances, the profit to be made is less than 1.2% of the total wager, so arbitrage betting is a long-term wagering strategy, rather than a short-term quick profit opportunity. Finding odds betting opportunities is complicated by the variety of ways in which the odds and contest details are listed by different betting platforms. In addition, bookmakers are increasingly aware of arbitrage betting and are becoming quicker to correct pricing errors and lower the odds variations between sites. This makes a digital platform that can normalize the notation differences between betting platforms, recognize betting odds opportunities, account for betting platform fees, aggregate the betting and game information, and notify the bettors of arbitrage betting opportunities in a timely manner, all of which create a valuable addition to the world of online betting.

Betting platforms include digital sportsbooks, which provide at least game-level outcome odds and accept wagers from bettors with an online account. Each betting platform has its own method of displaying the information regarding the sports contest, schedule, and odds. The variations in betting odds on different betting platforms can also provide an opportunity for the bettor. Arbitrage betting is a method of placing wagers with different digital betting platforms so that the bettor can make a profit regardless of the outcome. Arbitrage conditions occur when there is a set of odds which represents all mutually exclusive outcomes that cover all outcome possibilities of an event. The great majority of arbitrage betting opportunities provides a return of less than 1.2%, so that relatively large money wagers are required to make a significant profit. A digital platform for evaluating betting odds can be used to parse the betting opportunities offered by multiple digital betting platforms. The digital platform accesses two or more digital betting platforms that provide betting odds opportunities. The digital platform can “normalize” disparate odds opportunities representations by parsing the odds opportunities. The parsing can enable matching of odds opportunities among digital betting platforms by matching disparate representations of a contestant name or team name, contest date, contest venue, or contest odds representation. The digital platform can detect a content trigger event corresponding to one or more betting odds opportunities. The digital platform can also identify a statistically mispriced bet, where the mispriced bet itself becomes a betting opportunity. The digital platform can notify interested online users of both betting opportunities and dynamically changing opportunities. The digital platform can aggregate the normalized odds and contest information and generate a human-readable online article. The online article can be published on the digital platform and notifications can be sent to interested online users.

Techniques for automated content generation are disclosed. Two or more digital betting platforms are accessed. The two or more digital betting platforms each provide one or more betting odds opportunities for an online user. The online user can access a digital platform using a web browser, a web form, a web app, an app loaded on a personal electronic device, and so on. The betting odds opportunities can include sporting and other events. The one or more betting odds opportunities are parsed from the two or more digital betting platforms to enable identification of at least one common betting odds opportunity. The parsing can recognize common betting odds opportunities by decoding abbreviations, expanding participant initials, substituting names for nicknames, converting calendar formats, etc. An odds discrepancy between the two or more digital betting platforms is identified for the common betting odds opportunity. The odds discrepancies can be attributable to modeling differences, differences in bookmaker opinion, delayed updates to odds, and the like. The common betting odds opportunity can trigger the digital platform to generate a human-readable online article containing aggregated data from the two or more betting platforms and detailing the betting odds opportunities. The online article can contain dynamic article features related to the betting odds opportunities. The online article can be published to the Internet and an automated notification can be provided to the online user. The notification can contain information on the common betting odds opportunity and the related online article. The notification can include a text message, an email message, an alert, an update on a webpage, and so on.

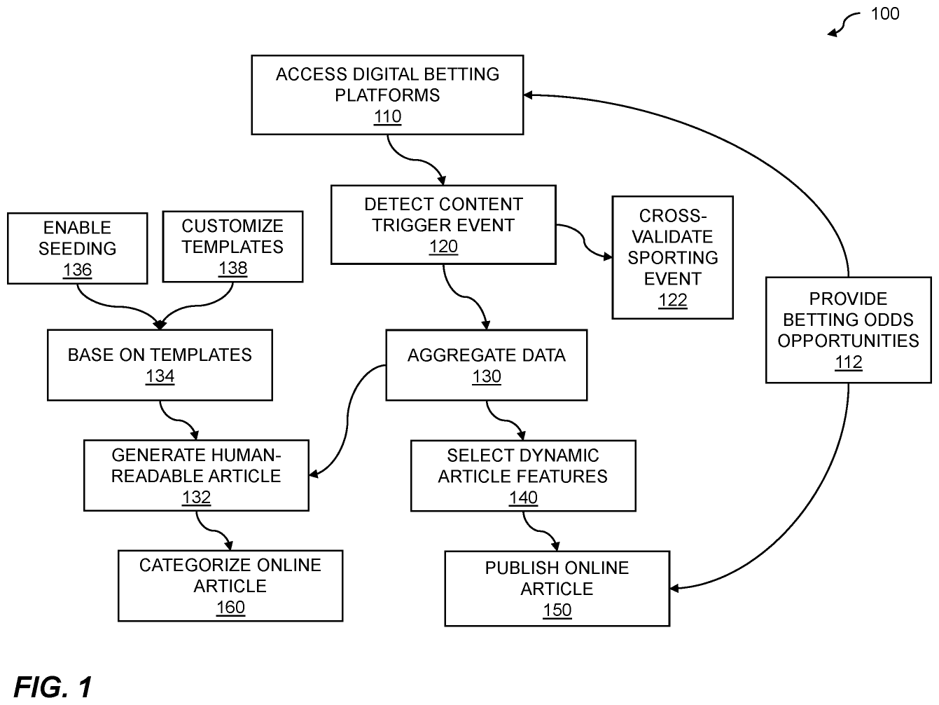

FIG. 1 is a flow diagram 100 for digital platform automatic content generation. The flow 100 includes accessing one or more digital betting platforms 110, wherein the one or more digital betting platforms each provide one or more betting odds opportunities for an online user, and wherein the one or more betting odds opportunities include sporting events. In embodiments, the one or more digital betting platforms comprise sportsbooks. Betting odds are determined by sportsbooks and offered through digital betting platforms to potential online bettors. Betting odds differences can occur between sportsbooks. By accessing two or more digital betting platforms, betting odds opportunities can be provided. The betting odds opportunities are parsed to enable identification of at least one common betting odds opportunity, such as a sporting event listed by the two or more sportsbooks. An online user interested in placing a bet can request the identified, common betting odds opportunity. The digital sportsbooks enable a user such as an online user to place bets on a variety of events such as sporting events. In embodiments, the digital sportsbooks can provide at least game-level outcome odds. In the flow 100, each of the one or more digital betting platforms provide one or more betting odds opportunities 112 for an online user. A betting opportunity can include placing a bet on a team, an individual contestant, multiple contestants, and so on. A betting odds opportunity can include betting on an outcome of a sporting contest. For example, a betting opportunity can include betting that a first team will defeat the second team in a sporting event.

The betting can further include a point spread. In embodiments, the outcome of the sporting contest can include winner, loser, total points, partial game points, game spread, game proposition bets or “props”, and individual contest props.

The flow 100 includes detecting a content trigger event 120, wherein the content trigger event corresponds to at least one of the one or more betting odds opportunities.

As sporting events are scheduled, digital betting sites post information about the event on their platforms. The posting can include information including players and teams involved, date and time of the event, location, etc. The posting can include the first-time odds for the sporting event. In embodiments, the content trigger event includes detecting a first-time posting of odds for a sporting event by the one or more digital platforms. As more bettors place bets, the odds and payout amounts can change. Additional information about players, weather conditions, coaching decisions, location conditions, etc. can influence the odds as well. In embodiments, the detecting can include cross-validating a sporting event 122, including an automatic website lookup, confirming the sporting event is active. Sporting events can be postponed, changed, or cancelled for many reasons. Weather conditions, player injuries, venue changes, and so on can generate alterations in a sporting event that can affect the betting odds on the event. Information on a sporting event can be accessed via one or more websites, including websites other than the digital betting platforms. The information from the additional websites can be parsed and used to confirm the information contained on the digital betting sites, including the time, date, and location of the event, and so on. As the sporting event is confirmed as active, the betting odds information from the one or more digital betting platforms can be parsed and analyzed for odds opportunities. The trigger event can include a fixed time cadence, including one or more of every six hours, every day, and every week. The refreshing of the odds information from the one or more digital betting platforms on a fixed time cadence allows changes in the various betting platform odds to be analyzed and allows new odds opportunities to be posted.

The detecting includes parsing the one or more betting odds opportunities from the two or more digital betting platforms. An odds opportunity can include an opportunity to bet on an event such as a sporting event. A sports betting platform can provide betting odds opportunities in a variety of data formats, graphical representations, and so on. The parsing enables identification of at least one common betting odds opportunity. A common odds opportunity can include a sporting event available on two or more digital betting platforms. A common odds opportunity can include a game such as a Boston Red Sox versus New York Yankees baseball game. In embodiments, the common betting odds opportunity can include a statistically mispriced bet. A statistically mispriced bet can occur due to a modeling error, a difference of opinion, a failure to act in a timely manner to an update such as a player injury, and so on. In embodiments, the statistically mispriced bet can enable a positive expected value betting outcome on one participant of the head-to-head sporting contest. The detecting at least one common betting odds opportunity can generate a content trigger event.

A variety of types of bets can be placed based on the identified common betting odds opportunity. In embodiments, the bet can be placed on each contestant of the head-to-head sporting contest. A bet on each contestant can comprise an arbitrage bet. An arbitrage bet can be based on different odds being offered by different sportsbooks. In embodiments, the bet on each contestant can guarantee a positive expected value betting outcome. The positive expected value can be based on an amount, a percentage, and so on. A bet based on a positive expected value can enable a positive return at lower risk to the bettor. In other embodiments, the bet on each contestant can include a low-hold bet. A low-hold bet can be based on a lower percentage collected on bets by a sportsbook maker. In embodiments, the bet on each contestant can include a middle bet. A middle bet can include placing bets on both outcomes of an event such as a sporting event. The bets are placed with different sportsbooks. A middle bet betting opportunity can occur when odds associated with an event are different on two or more different sportsbooks. The parsing can include matching disparate representations of a contestant name, contest date, contest venue, or contest odds representation. For example, disparate representations of a contestant name can include name representations such as first name-last name, last name-first name, first initial-last name, last name-first initial, and so on. The disparate representations can include nicknames. In embodiments, the parsing can include conversion of disparate contest odds representations. Odds representations can include decimal, fractional, percentage, American, and the like.

The flow 100 includes aggregating data 130 from the at least one of the one or more betting odds opportunities, wherein the data enables generating a human-readable online article. As the data from the one or more digital betting platforms is accessed and parsed, the information related to same sporting events can be aggregated so that all the data related to a specific sporting event can be assembled into a human-readable online article 132. The data from each of the one or more betting platforms can be stated in a like manner so that the similarities and differences between odds offered on the same sporting events by different betting platforms can be viewed and analyzed by bettors. In embodiments, the generating of the human-readable online articles 132 is based on one or more templates 134. A template is a computer document file that can receive data element input, such as text, pictures, widgets, and so on, from a separate data file. The data elements from the input data file are combined with text and graphics elements included in the template file. The input data elements are placed into designated placeholder positions within the template file and combined with the text and graphics data embedded in the template file to produce a separate document file. The separate document file comprises a human-readable article 132, combining the aggregated data from the one or more digital betting platforms with text and graphics included in the template file. The template can be designed to generate a human-readable article in a format suitable for online access. Templates can be customized 138, wherein the customizing is based on the one or more betting opportunities. A template can include optional phrases, sentences, and paragraphs that are rendered upon conditions that arise from the data elements included in the input data file.

The customizing includes data obtained from sources different from the one or more digital betting platforms, including sporting event game variables and league variables.

The one or more templates enable seeding 136 a machine learning model. Artificial intelligence (AI) text generation is a type of natural language processing (NLP) that can create text from a given input set. For example, the aggregated data from one or more digital betting platforms combined with sporting event game variables and league variables can be used as seed input to an AI machine learning text generation model. The AI machine learning model can be used to generate human-like text from the given input, using a combination of machine learning algorithms and natural language processing techniques. The model algorithms can be trained with a large body of text, including sports books, sports magazine and newspaper articles, and other text sources including sports booking platform articles. The AI text generation model algorithms can then be used to generate text from data which has been input from similar sources, such as the digital betting platform information. In some embodiments, the text generating process can use a two-step approach. The first step is to use the AI machine learning algorithms to take an input data and generate an output text file. The second step is to evaluate the output text file, looking for ways to improve the output. The evaluation process can include grammar and syntax verification, spell checking, and so on. Human evaluators can be used to make improvements related to style, appropriate colloquialisms, etc. As the AI text generation model takes in more input over time, the ability to generate human-readable text articles improves. In some embodiments, the machine learning model can replace one or more templates.

The flow 100 includes selecting one or more dynamic article features 140 related to the at least one of the one or more betting odds opportunities. In embodiments, the dynamic article features can include images, embedded widgets, and categories related to a sporting event described by the one or more betting odds opportunities. As individual sporting events are identified and the betting odds and other information related to the sporting events are parsed, placed into matching expressions, and aggregated, additional features can be added to the human-readable online articles being generated. Images related to a specific sporting event, widgets directing bettors to related articles or team websites, hypertext links to league websites, and so on can be added into the human-readable online articles. For instance, a picture of two teams playing against each other from a previous year can be included in an online article related to a future event involving the same two teams. Widgets representing the team logos can be included in the online article that can start a separate browser page with the team website, or hyperlinks to the league website can be embedded in the online article as they are related to a sporting event described by the one or more betting odds opportunities. The resulting document, including all the relevant dynamic features, can be published as a complete human-readable online article 150.

The flow 100 includes publishing the online article 150, wherein the online article includes the at least one of the one or more betting odds opportunities and the one or more dynamic article features 140. Initiating the publishing facilitates batch concurrent publishing of a plurality of online articles. In embodiments, the one or more betting odds opportunities can be identified and generated for one or more sports events at the same time. This can result in one or more online articles being generated and prepared to publish at the same time. Batch publishing of the human-readable online articles can allow control over the number and timing of generated online articles being published at one time. In embodiments, a random number generator can be used to initiate the publishing of the online articles 150. A random number generator can be used to select a different number of online articles to be generated in each batch of articles to be published. Publishing a different number of human-readable online articles in batches enables search engine optimization (SEO). Search engine optimization is a set of website practices that is designed to improve a site's ranking in the non-paid section of search results from Internet search engines. A significant percentage of all traffic on the Internet comes from search engines. Controlling the rate at which new or refreshed online articles are added to a website allows time for the various search engines to rank the website without flagging the added online articles as spam.

In embodiments, the publishing includes categorizing the online article 160 based on the sporting event game variables and the league variables. In embodiments, the categorizing allows the online articles to be grouped by time and date, sport, sports league, location, and so on. This simplifies the locating of articles related to the bettors' interests. The online articles can also be ranked based on the potential gain or loss identified in the betting odds opportunities. The publishing includes refreshing the online article that was published. The refreshing rate is determined by a variable contained in the template. The refreshing rate can be varied based on the time proximity of the related sports event, the number of bets received for the sports event, and so on. As the date and time of a particular sports event draws nearer, the refreshing rate for the related online articles can be made more or less frequently as necessary.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

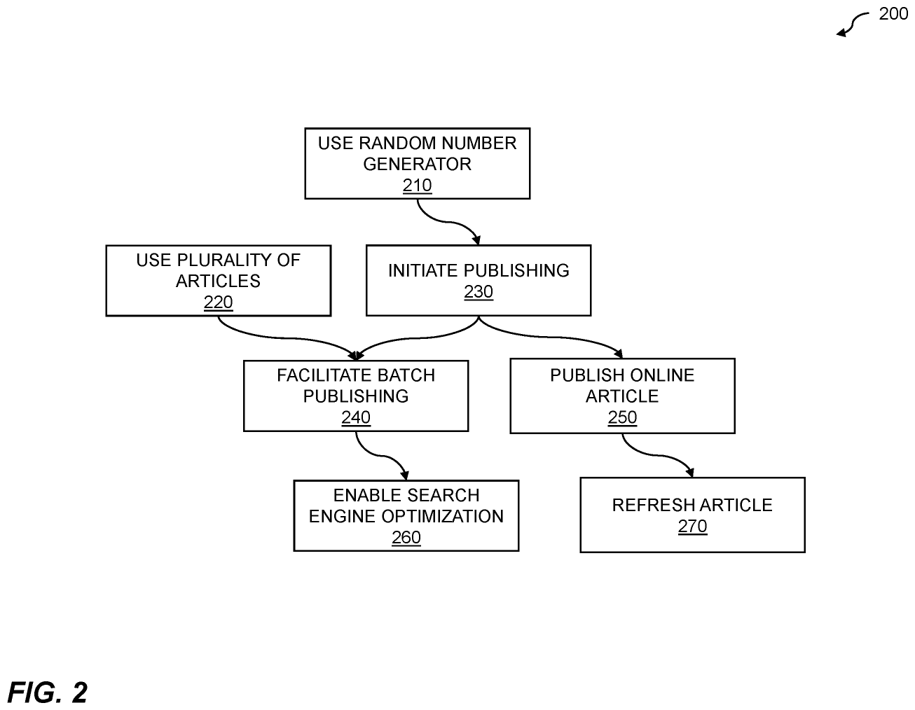

FIG. 2 is a flow diagram 200 for publishing automated content. As noted above and throughout, one or more digital betting platforms can be accessed, wherein each digital betting platform can provide one or more betting odds opportunities for an online user, including sporting events. By accessing two or more digital betting platforms, betting odds opportunities can be provided. The betting odds opportunities can be parsed to enable identification of at least one common betting odds opportunity, such as a sporting event listed by the two or more sportsbooks. In embodiments, the digital sportsbooks can provide at least game-level outcome odds. As sporting events are scheduled, digital betting sites post information about the event on their platforms. The posting can include information including players and teams involved, date and time of the event, location, etc. Information on a sporting event can be accessed via one or more websites, including websites other than the digital betting platforms. The information from the additional websites can be parsed and used to confirm the information contained on the digital betting sites, including the time, date, and location of the event, and so on. As the sporting event is confirmed as active, the betting odds information from the one or more digital betting platforms can be parsed and analyzed for odds opportunities. As the data from the one or more digital betting platforms is accessed and parsed, the information related to the same sporting events can be aggregated so that all the data related to a specific sporting event can be assembled into a human-readable online article. The data from each of the one or more betting platforms can be stated in a like manner so that the similarities and differences between odds offered on the same sporting events by different betting platforms can be viewed and analyzed by bettors.

The flow 200 includes using a random number generator 210 to initiate publishing 230 of human-readable online articles. A random number generator (RNG) is a hardware device or software program that is designed to generate a random set of numbers that do not follow any distinguishable pattern in appearance or generation. In embodiments, a random number generator can be used to select a different number of human-readable online articles to be generated in a plurality of articles 220 to be published. The accessing one or more digital betting platforms can result in one or more betting odds opportunities being identified for one or more sports events at the same time. Identifying one or more betting odds opportunities can result in one or more online articles being generated and prepared to publish at the same time. Batch publishing of the human-readable online articles can allow control over the number and timing of generated online articles being published at one time. Using a random number generator 210 to set the number of a plurality of online articles 220 in each batch publishing 240 cycle enables search engine optimization (SEO) 260. Search engine optimization is a set of website practices that is designed to improve a site's ranking in the non-paid section of search results from Internet search engines. A significant percentage of all traffic on the Internet comes from search engines. Controlling the rate at which new or refreshed online articles are added to a website allows time for the various search engines to rank the website in its non-paid section without flagging the added online articles on the host website as spam. When large numbers of online articles that contain many similar sentences and phrases are generated by a computer system and rapidly added to a website or emailed to a group of users, search engine and email host algorithms can conclude that the online articles are spam. Spam is unsolicited Internet content that is typically sent in bulk for advertising purposes. Using a random number generator to change the number of online articles generated and published by batch publishing can work to prevent search engine algorithms from flagging the online articles as spam.

The flow 200 includes publishing an online article 250. In embodiments, as data from the one or more digital betting platforms is accessed and parsed, the information related to same sporting events can be aggregated so that all the data related to a specific sporting event can be assembled into a human-readable online article. The data from each of the one or more betting platforms can be stated in a like manner so that the similarities and differences between odds offered on the same sporting events by different betting platforms can be viewed and analyzed by bettors. In embodiments, the generating of the human-readable online articles is based on one or more templates. A template is a computer document file that can receive data element input, such as text, pictures, widgets, and so on, from a separate data file. The data elements from the input data file are combined with text and graphics elements included in the template file. The input data elements are placed into designated placeholder positions within the template file and combined with the text and graphics data embedded in the template file to produce a separate document file. The separate document file comprises a human-readable article, combining the aggregated data from the one or more digital betting platforms with text and graphics included in the template file. The template can be designed to generate a human-readable article in a format suitable for online access. Templates can be customized, wherein the customizing is based on the one or more betting opportunities. A template can include optional phrases, sentences, and paragraphs that are rendered upon conditions that arise from the data elements included in the input data file. The customizing includes data obtained from sources different from the one or more digital betting platforms, including sporting event game variables and league variables. Once the human-readable online article has been generated, it can be published by adding it to a host website or sending it to one or more bettors by email. In some embodiments, the bettors can receive a notification by text, email, voice mail, etc. The notification can include a hypertext link to the online article on the host website.

The flow 200 includes refreshing an article 270. Refreshing the article includes accessing the one or more digital betting platforms, analyzing and identifying betting odds opportunities related to the same sporting event highlighted in the article, generating an updated version of the online article, and publishing the updated version of the article in place of the previous version. In embodiments, the refreshing rate can be determined by a variable contained in the online article template. The refreshing rate can be varied based on the time proximity of the related sports event, the number of bets received for the sports event, and so on. As the date and time of a particular sports event draws nearer, the refreshing rate for the related online articles can be made more or less frequent as necessary. In some embodiments, the refreshing of the online article can include information related to postponement or cancellation of a sporting event. The postponement or cancellation online article can include information regarding the condition of any bets placed prior to the change in the schedule of the sporting event.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

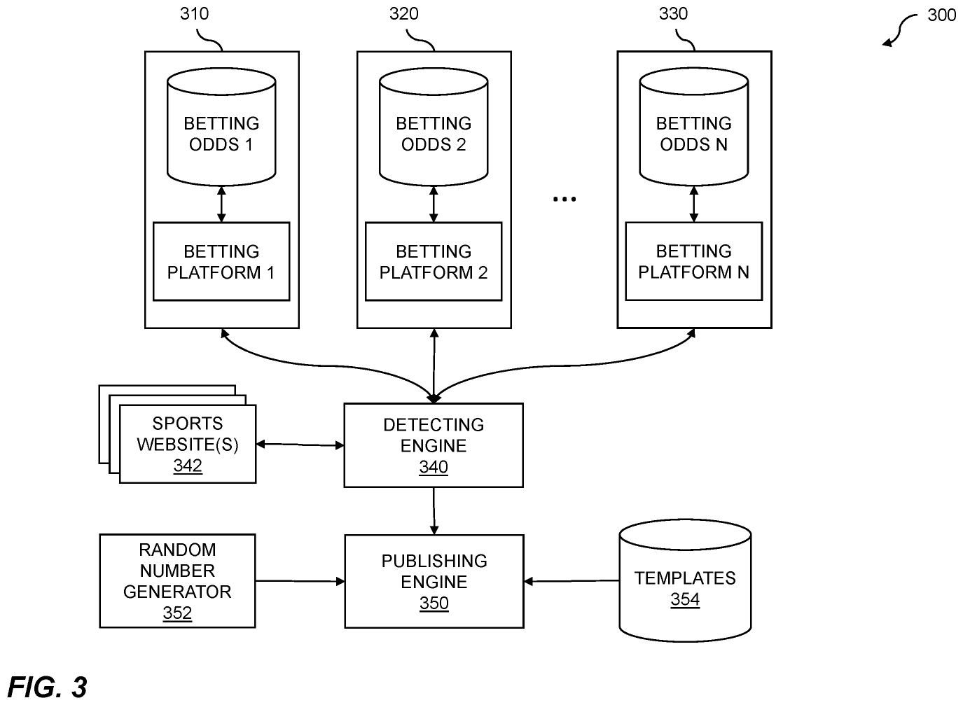

FIG. 3 is a block diagram for a digital platform for automated content generation. The block diagram 300 includes accessing one or more betting platforms 310, 320, 330, wherein the one or more digital betting platforms each provide one or more betting odds opportunities for an online user, and wherein the one or more betting odds opportunities include sporting events. In embodiments, the one or more digital betting platforms comprise sportsbooks. Betting odds are determined by sportsbooks and offered through digital betting platforms to potential online bettors. Betting odds differences can occur between sportsbooks. By accessing two or more digital betting platforms, betting odds opportunities can be provided. The betting odds opportunities are parsed to enable identification of at least one common betting odds opportunity, such as a sporting event listed by the two or more sportsbooks. An online user interested in placing a bet can request the identified, common betting odds opportunity. A bet on each contestant can comprise an arbitrage bet. An arbitrage bet can be based on different odds being offered by different sportsbooks. In embodiments, the bet on each contestant can guarantee a positive expected value betting outcome. The positive expected value can be based on an amount, a percentage, and so on. A bet based on a positive expected value can enable a positive return at lower risk to the bettor. In other embodiments, the bet on each contestant can include a low-hold bet. A low-hold bet can be based on a lower percentage collected on bets by a sportsbook maker. In embodiments, the bet on each contestant can include a middle bet. A middle bet can include placing bets on both outcomes of an event such as a sporting event. The bets are placed with different sportsbooks. A middle bet betting opportunity can occur when odds associated with an event are different on two or more different sportsbooks. The digital sportsbooks enable a user such as an online user to place bets on a variety of events such as sporting events. In embodiments, the digital sportsbooks can provide at least game-level outcome odds. In the block diagram 300, each of the one or more digital betting platforms provides one or more betting odds opportunities for an online user. A betting opportunity can include placing a bet on a team, an individual contestant, multiple contestants, and so on. A betting odds opportunity can include betting on an outcome of a sporting contest. For example, a betting opportunity can include betting that a first team will defeat a second team in a sporting event. The betting can further include a point spread. In embodiments, the outcome of the sporting contest can include winner, loser, total points, partial game points, game spread, game proposition bets or “props”, and individual contest props.

The block diagram 300 includes a detecting engine 340. In embodiments, as sporting events are scheduled, digital betting platforms 310, 320, 330 post information about the event on their platforms. The posting can include information including players and teams involved, date and time of the event, location, etc. The posting can include the first-time odds for the sporting event. In embodiments, the detecting engine can detect a first-time posting of odds for a sporting event by the one or more digital platforms. As more bettors place bets, the odds and payout amounts can change. Additional information about players, weather conditions, coaching decisions, location conditions, etc. can influence the odds as well. In embodiments, the detecting engine can include cross-validating a sporting event, including an automatic sports website lookup 342, confirming that the sporting event is active. Sporting events can be postponed, changed, or cancelled for many reasons. Weather conditions, player injuries, venue changes, and so on can generate alterations in a sporting event that can affect the betting odds on the event. Information on a sporting event can be accessed via one or more sports websites 342, including websites other than the digital betting platforms. The information from the additional websites can be parsed and used to confirm the information contained on the digital betting sites, including the time, date, and location of the event, and so on. As the sporting event is confirmed as active, the betting odds information from the one or more digital betting platforms can be parsed and analyzed for odds opportunities. The detecting engine can include a fixed time cadence, including one or more of every six hours, every day, and every week. The refreshing of the odds information from the one or more digital betting platforms on a fixed time cadence allows changes in the various betting platform odds to be analyzed and new odds opportunities to be posted.

The detecting engine can include parsing the one or more betting odds opportunities from the two or more digital betting platforms 310, 320, 330. An odds opportunity can include an opportunity to bet on an event such as a sporting event. A sports betting platform can provide betting odds opportunities in a variety of data formats, graphical representations, and so on. The parsing enables identification of at least one common betting odds opportunity. A common odds opportunity can include a sporting event available on two or more digital betting platforms. A common odds opportunity can include a game such as a Boston Red Sox versus

New York Yankees baseball game. In embodiments, the common betting odds opportunity can include a statistically mispriced bet. A statistically mispriced bet can occur due to a modeling error, a difference of opinion, a failure to act in a timely manner to an update such as a player injury, and so on. In embodiments, the statistically mispriced bet can enable a positive expected value betting outcome on one participant of the head-to-head sporting contest. The detecting engine can detect at least one common betting odds opportunity that can generate a content trigger event. The content trigger event can start the generation of a human-readable online article that can be published to bettors and host websites.

The block diagram 300 includes a publishing engine 350. In embodiments, as the data from the one or more digital betting platforms 310, 320, 330 is accessed and parsed, the information related to same sporting events can be aggregated so that all the data related to a specific sporting event can be assembled into a human-readable online article. The data from each of the one or more betting platforms can be stated in a like manner so that the similarities and differences between odds offered on the same sporting events by different betting platforms can be viewed and analyzed by bettors. The data from the digital betting platforms can be combined with the betting odds opportunities data generated by the detecting engine 340 to populate a human-readable online article detailing the betting odds opportunities and the particulars of the related sporting event. The publishing engine 350 can generate the human-readable online articles based on one or more templates 354. A template is a computer document file that can receive data element input, such as text, pictures, widgets, and so on, from a separate data file. The data elements from the input data file are combined with text and graphics elements included in the template file. The input data elements are placed into designated placeholder positions within the template file and combined with the text and graphics data embedded in the template file to produce a separate document file. The separate document file comprises a human-readable article, combining the aggregated data from the one or more digital betting platforms, information about the detected betting odds opportunities, and text and graphics included in the template file. The template can be designed to generate a human-readable article in a format suitable for online access. Templates can be customized, wherein the customizing is based on the one or more betting opportunities. A template can include optional phrases, sentences, and paragraphs that are rendered upon conditions that arise from the data elements included in the input data file. The customizing includes data obtained from sources different from the one or more digital betting platforms, including sporting event game variables and league variables.

In embodiments, the publishing engine 350 can use batch publishing to generate one or more human-readable online articles at the same time. Initiating the publishing engine facilitates batch publishing of a plurality of online articles. The one or more betting odds opportunities can be detected by the detecting engine 340 and generated for one or more sports events at the same time. This can result in one or more online articles being generated and prepared to publish by the publishing engine at the same time. Batch publishing of the human-readable online articles can allow control over the number and timing of generated online articles being published at one time. In embodiments, a random number generator 352 can be used to initiate the publishing of the online articles. A random number generator 352 can be used to select a different number of online articles to be generated in each batch of articles to be published. Publishing a different number of human-readable online articles in batches enables search engine optimization (SEO). Search engine optimization is a set of website practices that is designed to improve a site's ranking in the non-paid section of search results from Internet search engines. A significant percentage of all traffic on the Internet comes from search engines. Controlling the rate at which new or refreshed online articles are added to a website allows time for the various search engines to rank the website without flagging the added online articles as spam. When large numbers of online articles that contain many similar sentences and phrases are generated and rapidly added to a website or emailed to a group of users, search engine and email algorithms can conclude that the online articles are spam. Spam is unsolicited Internet content that is typically sent in bulk for advertising purposes. Using a random number generator 352 to change the number of online articles generated and published by a publishing engine 350 can work to prevent search engine algorithms from flagging the online articles as spam.

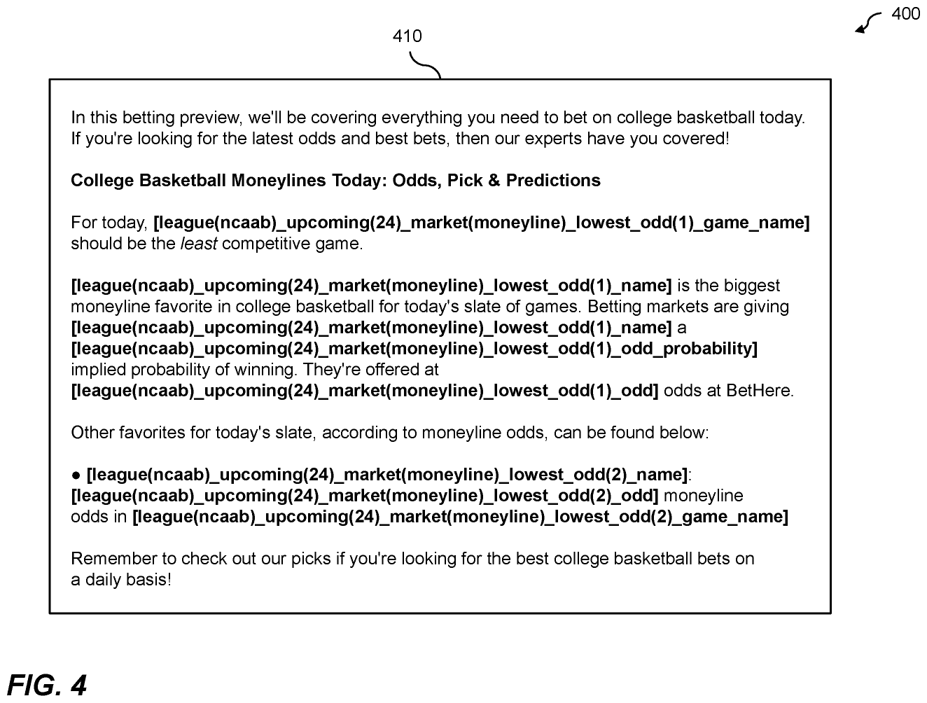

FIG. 4 is a first example of a template. As described above and throughout, a template is a computer document file that can receive data element input, such as text, pictures, widgets, and so on, from a separate data source. The data from the one or more digital betting platforms can come from a separate data file supplied by the betting platform vendor, a text-only version of betting platform webpages, or information that is screen scraped from a betting platform. Screen scraping is a method of capturing visual data on web pages as raw text. The raw text must be analyzed and parsed to categorize the information. Third-party programs and websites can be used to simplify the screen scraping process. The data elements from an input data file can be combined with text and graphics elements included in the template file. The input data elements are placed into designated placeholder positions within the template file and combined with the text and graphics data embedded in the template file to produce a separate document file. In the example 400, template 410 illustrates several data elements that can be imported from one or more digital betting platforms to populate all the placeholders in the template. In embodiments, the data used to populate the template can be sorted before being fed into the template to make the generation of the online article as efficient as possible.

The separate document file comprises a human-readable article, combining the aggregated data from the one or more digital betting platforms, information about the detected betting odds opportunities, and text and graphics included in the template file 410. The template can be designed to generate a human-readable article in a format suitable for online access. Templates can be customized, wherein the customizing is based on the one or more betting opportunities. A template can include optional phrases, sentences, and paragraphs that are rendered upon conditions that arise from the data elements included in the input data file. The customizing includes data obtained from sources different from the one or more digital betting platforms, including sporting event game variables and league variables.

The example 400 includes a template 410. In the first example template 410, regular text appears as it does in a human-readable word processing document. The template 410 regular text begins, “In this betting preview, we'll be covering everything you need to bet on college basketball today.” Bold text appears as bold, italics as italics, and so on. The text continues through the words “For today,”. Immediately following the “For today” (including the comma and space), the data element placeholder appears. In the example 410, data element placeholders are designated with brackets [ ] to mark the beginning and ending of a placeholder.

In embodiments, the placeholder names can be simple or elaborate, depending on the number of placeholders and placeholder elements being used. In template 410, the first placeholder name is “league(ncaab)_upcoming(24)_market(moneyline)_lowest_odd(1)_game_name”. The placeholder name can be used to indicate specific details about the data element. In the example above, the game name is for an upcoming NCAAB college basketball game. It is a game with the lowest moneyline odds at the time the data was captured from one or more digital betting platforms. When the human-readable online article is rendered, the line could read, “For today, Rosencrantz at Guildenstern should be the least competitive game.” A moneyline wager is a bet placed on a game's outcome. In other words, it is a bet on which team or competitor will win a given sports event. Payouts for a moneyline bet are based on the given odds of a game. The odds are split into favorites and underdogs. A negative number indicates a competitor or team that is the favorite, such as −150. The number indicates the amount of money that needs to be wagered to win $100. In the above example, a bettor will have to wager $150 on Guildenstern to win a $100 payout should Guildenstern win the event. Positive moneyline numbers indicate an underdog or the team that is expected to lose the game. In the example above, the moneyline odds might be quoted at +145. This number indicates the amount of money paid out for a $100 bet if the underdog team wins the game. If Rosencrantz won the basketball game in the example above, a bettor who wagered $100 would receive a payout of $145 along with the original wager of $100, or a total of $245.

As the template file is populated with input data from the one or more digital betting platforms, the remainder of the human-readable online article is filled in and rendered. In the example template 410, the completed article can read as follows: “In this betting preview, we'll be covering everything you need to bet on college basketball today. If you're looking for the latest odds and best bets, then our experts have you covered! College Basketball Moneylines Today: Odds, Pick & Predictions For today, Rosencrantz vs. Guildenstern should be the least competitive game. Guildenstern is the biggest moneyline favorite in college basketball for today's slate of games. Betting markets are giving Guildenstern a 60% implied probability of winning. They're offered at −150 odds at BetHere.”

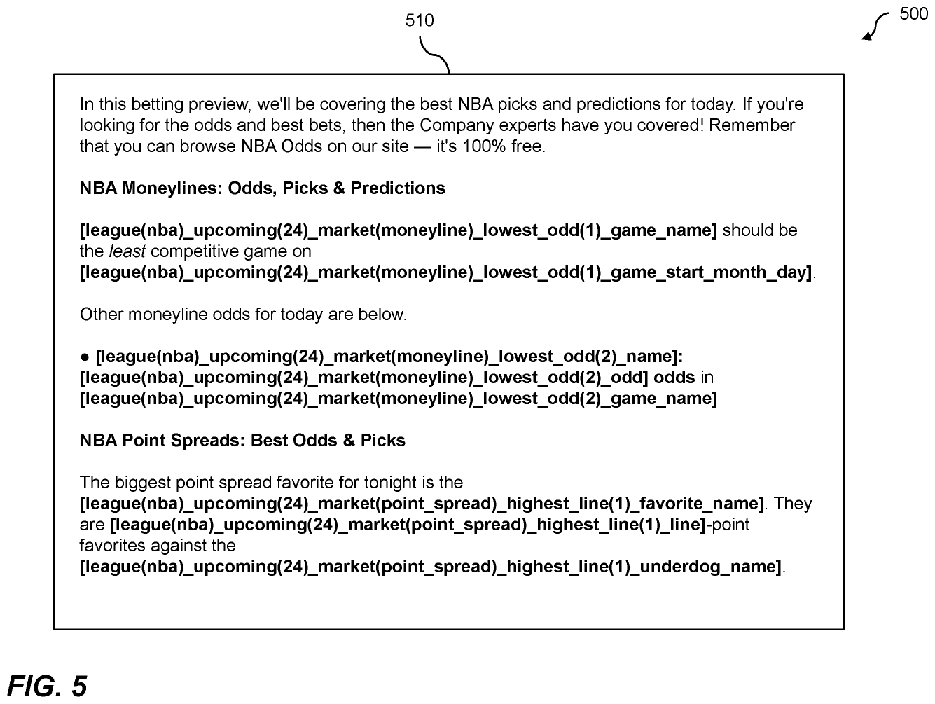

FIG. 5 is a second example of a template. As described above and throughout, a template is a computer document file that can receive data element input, such as text, pictures, widgets, and so on, from a separate data source. The data from the one or more digital betting platforms can come from a separate data file supplied by the betting platform vendor, a text-only version of betting platform webpages, or information that is screen scraped from a betting platform. Screen scraping is a method of capturing visual data on web pages as raw text. The raw text must be analyzed and parsed to categorize the information. Third-party programs and websites can be used to simplify the screen scraping process. The data elements from an input data file can be combined with text and graphics elements included in the template file. The input data elements are placed into designated placeholder positions within the template file and combined with the text and graphics data embedded in the template file to produce a separate document file. In the example 500, template 510 illustrates several data elements that can be imported from one or more digital betting platforms to populate all the placeholders in the template. In embodiments, the data used to populate the template can be sorted before being fed into the template to make the generation of the online article as efficient as possible.

The separate document file comprises a human-readable article, combining the aggregated data from the one or more digital betting platforms, information about the detected betting odds opportunities, and text and graphics included in the template file 510. The template can be designed to generate a human-readable article in a format suitable for online access. Templates can be customized, wherein the customizing is based on the one or more betting opportunities. A template can include optional phrases, sentences, and paragraphs that are rendered upon conditions that arise from the data elements included in the input data file. The customizing includes data obtained from sources different from the one or more digital betting platforms, including sporting event game variables and league variables.

The flow 500 includes a template 510. In the second example template 510, regular text appears as it does in a human-readable word processing document. The template 510 regular text begins, “In this betting preview, we'll be covering the best NBA picks and predictions for today.” Bold text appears as bold, italics as italics, and so on. The text continues through the words “NBA Moneylines: Odds, Picks & Predictions”. Immediately following the Picks & Predictions title, the first data element placeholder appears. In the example 510, data element placeholders are designated with brackets [ ] to mark the beginning and ending of a placeholder. In embodiments, the placeholder names can be simple or elaborate, depending on the number of placeholders and placeholder elements being used. In template 510, the first placeholder name is “league(nba)_upcoming(24)_market(moneyline)_lowest_odd(1)_game_-name”. The placeholder name can be used to indicate specific details about the data element. In the example above, the game name is for an upcoming NBA professional basketball game. It is a game with the lowest moneyline odds at the time the data was captured from one or more digital betting platforms. When the human-readable online article is rendered, the line could read, “For today, Hamlet at Denmark Castle should be the least competitive game.” A moneyline wager is a bet placed on a game's outcome. In other words, a bet is placed on which team or competitor will win a given sports event. Payouts for a moneyline bet are based on the given odds of a game. The odds are split into favorites and underdogs. A negative number indicates a competitor or team that is the favorite, such as −150. The number indicates the amount of money that needs to be wagered to win $100. In the above example, a bettor will have to wager $150 on Denmark Castle to win a $100 payout should Denmark Castle win the event. Positive moneyline numbers indicate an underdog or the team that is expected to lose the game. In the example above, the moneyline odds might be quoted at +145. This number indicates the amount of money paid out for a $100 bet if the underdog team wins the game. If

Hamlet won the basketball game in the example above, a bettor who wagered $100 would receive a payout of $145 along with the original wager of $100, or a total of $245.

As the template file is populated with input data from the one or more digital betting platforms, the remainder of the human-readable online article is filled in and rendered. In the example template 410, the completed article can read as follows: “In this betting preview, we'll be covering the best NBA picks and predictions for today. If you're looking for the odds and best bets, then the Company experts have you covered! Remember that you can browse NBA Odds on our site—it's 100% free. NBA Moneylines: Odds, Picks and Predictions Hamlet vs. Denmark Castle should be the least competitive game on March 15.”

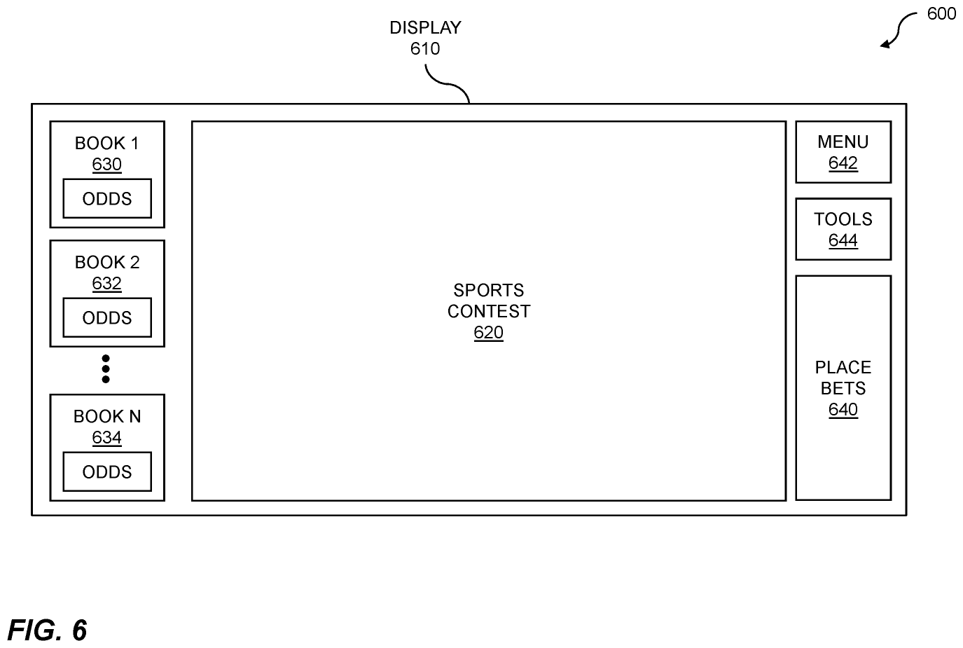

FIG. 6 illustrates a digital platform user interface. In embodiments, one or more digital betting platforms can be accessed, wherein each digital betting platform can provide one or more betting odds opportunities for an online user, including sporting events. By accessing two or more digital betting platforms, betting odds opportunities can be provided. The betting odds opportunities can be parsed to enable identification of at least one common betting odds opportunity, such as a sporting event listed by the two or more sportsbooks. The digital sportsbooks can provide at least game-level outcome odds. As sporting events are scheduled, digital betting sites post information about the event on their platform. The posting can include information including players and teams involved, date and time of the event, location, etc. Information on a sporting event can be accessed via one or more websites, including websites other than the digital betting platforms. The information from the additional websites can be parsed and used to confirm the information contained on the digital betting sites, including the time, date, and location of the event, and so on. As the sporting event is confirmed as active, the betting odds information from the one or more digital betting platforms can be parsed and analyzed for odds opportunities. As the data from the one or more digital betting platforms is accessed and parsed, the information related to same sporting events can be aggregated so that all the data related to a specific sporting event can be assembled into a human-readable online article. The data from each of the one or more betting platforms can be stated in a like manner so that the similarities and differences between odds offered on the same sporting events by different betting platforms can be viewed and analyzed by bettors.

A bettor can engage in activities such as online sports betting by interacting with a user interface (UI) associated with a digital platform for sports betting. The user interface can be rendered on a display of an electronic device associated with the bettor. The user interface can enable the bettor to interact with the sports betting platform, where the interacting can include requesting information, observing opportunities, placing one or more bets, and so on. The user interface supports a digital platform for evaluating betting odds. Two or more digital betting platforms are accessed, wherein the two or more digital betting platforms each provide one or more betting odds opportunities for an online user. The one or more betting odds opportunities are parsed from the two or more digital betting platforms to enable identification of at least one common betting odds opportunity. An odds discrepancy is identified between the two or more digital betting platforms for the common betting odds opportunity. A request is received from the online user for the common betting odds opportunity. An automated response is provided to the online user, wherein the response contains information on the common betting odds opportunity.

The illustration 600 includes a display 610. In embodiments, a digital platform user interface that enables viewing of sporting events, sportsbook information, betting tools, and so on can be accessed and displayed on many types of devices, including connected televisions (CTVs), personal computers, laptops, tablets, mobile phones, PDAs, smartwatches, and other devices that can access the Internet and support a browser application. The connection to the Internet can be enabled via physical network or cable wiring, Wi-Fi, satellite, and so on.

The illustration 600 includes a sports contest 620. In embodiments, as sports contests 620 that provide betting odds opportunities for online users occur, they can be shown in a portion of the display 610. The presentation of the sports contest can include a video feed associated with the contest, a video feed with accompanying commentary, and the like. The user interface can include one or more sportsbooks, where the sportsbooks can include sportsbook 1 630, sportsbook 2 632, sportsbook N 634, and so on. The one or more sportsbooks can include odds. The odds can be associated with the sports contest, such as a head-to-head contest, an event within the head-to-head contest, etc. The contest can include a three or more participant contest. The odds can further be associated with sport-specific non-game events, one or more futures bets, etc. The user interface can enable placing one or more bets 640. The placing one or more bets can be accomplished by entering an amount to be wagered, choosing a sportsbook, and the like. The bets can be placed using one or more betting platforms accessed by the digital platform. The user interface can include a menu 642. The menu can be used to select an event to be rendered with the user interface, to save sports contest data, etc. The user interface can include tools 644. The tools can be used to configure the user interface, where the configuration can include a size and resolution of the interface, several sportsbooks to be displayed, types of events that the individual prefers, user identification and subscription information, user login credentials, and so on.

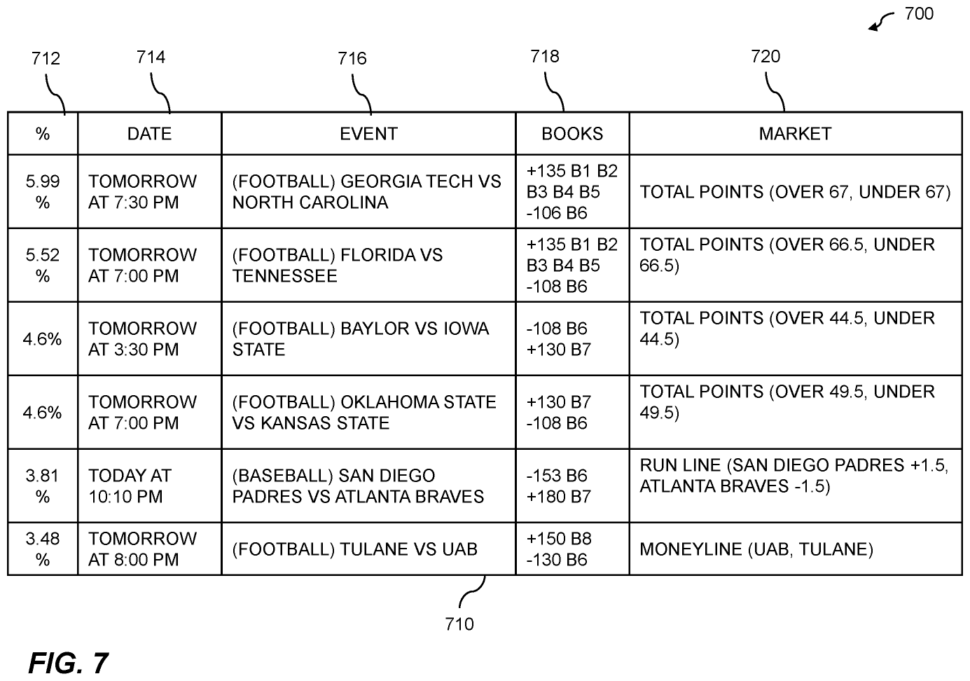

FIG. 7 is a table showing sports betting opportunities 700. Discussed above and throughout, sports betting opportunities can be provided by digital betting platforms. The digital betting platforms can be accessed via the Internet and can be positioned at various locations. The locations can include domestic locations, international locations, and so on. The sports betting opportunities can be received for examination, placing bets, and the like, by accessing the digital betting planforms. The betting opportunities can be parsed, and odds discrepancies can be identified from the parsed opportunities. The odds discrepancies can be identified using a digital platform for evaluating betting odds. Two or more digital betting platforms are accessed, wherein the two or more digital betting platforms each provide one or more betting odds opportunities for an online user. The one or more betting odds opportunities from the two or more digital betting platforms are parsed to enable identification of at least one common betting odds opportunity. An odds discrepancy is identified between the two or more digital betting platforms for the common betting odds opportunity. A request is received from the online user for the common betting odds opportunity. An automated response is provided to the online user, wherein the response contains information on the common betting odds opportunity.

A table 710 of sports betting opportunities is shown. The betting opportunities can be based on arbitrage betting. In embodiments, a bet on each contestant comprises an arbitrage bet. The table 710 can include a percentage 712 column. The percentage can indicate a percentage return resulting from placing an arbitrage bet. For an arbitrage bet, a bettor places one or more bets on all outcomes of an event. The bets are placed with different sportsbooks. The different sportsbooks can offer different odds based on differing opinions about odds, errors in setting odds, delays in discovering and amending errors in setting odds, and so on. The table can include a date column 714. A date within the date column can result from parsing data obtained by accessing two or more digital betting platforms. The parsing can analyze date information presented in differing data representation formats. The date can include the current date; a relative date such as today, tomorrow, or Saturday; etc. The date can further include an associated time. The time can include a local time for an event, a relative time such as the local time associated with a bettor, a relative time such as “two hours from now”, universal time (UTC), etc. The table can include an event column 716. The event column can include a type of sport such as American football, football (soccer), baseball, basketball, tennis, cycling, Olympic events, and the like. The event column can further include the teams, individuals, countries, and others who can be participating in the event. The table can include a books column 718. Based on the American standard for sportsbooks, a negative number can indicate a favorite in the event, while a positive number can indicate an underdog in the event. A number such as −106 can indicate an amount that can be wagered to win $100, while a number such as +130 can indicate an amount that can be won based on a $100 wager. The books column can also indicate one or more sportsbooks, such as B1, B2, B3, B4, B5, B6, B7, and B8. The table 700 can include a market column 720. The market can include total points, a run line, a moneyline, a spread, and so on.

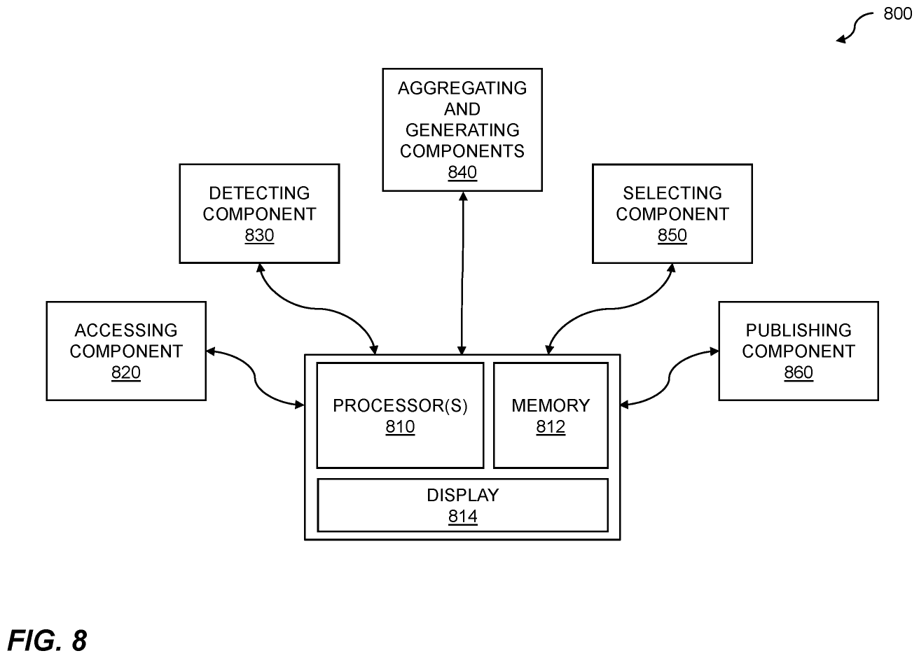

FIG. 8 is a system diagram for a digital platform for automated content generation. The system 800 can include one or more processors 810 coupled to a memory 812 which stores instructions. The system 800 can include a display 814 coupled to the one or more processors 810 for displaying data, video streams, videos, intermediate steps, instructions, and so on. In embodiments, one or more processors 810 are coupled to the memory 812 where the one or more processors, when executing the instructions which are stored, are configured to: access one or more digital betting platforms, wherein the one or more digital betting platforms each provide one or more betting odds opportunities for an online user, and wherein the one or more betting odds opportunities include sporting events; detect a content trigger event, wherein the content trigger event corresponds to at least one of the one or more betting odds opportunities; aggregate data from the at least one of the one or more betting odds opportunities, wherein the data enables generating a human-readable online article; select one or more dynamic article features related to the at least one of the one or more betting odds opportunities; and publish the online article, wherein the online article includes the at least one of the one or more betting odds opportunities and the one or more dynamic article features.

The system 800 includes an accessing component 820. The accessing component 820 can include functions and instructions for providing content generation for accessing one or more digital betting platforms, wherein the one or more digital platforms each provide one or more betting odds opportunities for an online user, and wherein the one or more betting opportunities include sporting events. In embodiments, the one or more digital betting platforms comprise sportsbooks. Betting odds are determined by sportsbooks and are offered through digital betting platforms to potential online bettors. The accessing component can access two or more digital betting platforms, wherein the two or more digital betting platforms can comprise digital sportsbooks. The digital sportsbooks enable a user such as an online user to place bets on a variety of events such as sporting events. In embodiments, the digital sportsbooks can provide at least game-level outcome odds. Betting odds differences can occur between sportsbooks. By accessing two or more digital betting platforms, betting odds opportunities can be provided. The betting odds opportunities are parsed to enable identification of at least one common betting odds opportunity, such as a sporting event listed by the two or more sportsbooks. An online user interested in placing a bet can request an identified, common betting odds opportunity.

The system 800 includes a detecting component 830. The detecting component 830 can include functions and instructions for detecting a content trigger event, wherein the content trigger event corresponds to at least one of the one or more betting odds opportunities. As sporting events are scheduled, digital betting sites post information about the events on their platforms. The posting can include information including players and teams involved, date and time of the event, location, etc. The posting can include the first-time odds for the sporting event. In embodiments, the content trigger event includes detecting a first-time posting of odds for a sporting event by the one or more digital platforms. As more bettors place bets, the odds and payout amounts can change. Additional information about players, weather conditions, coaching decisions, location conditions, etc. can influence the odds as well. In embodiments, the detecting can include cross-validating a sporting event, based on the detecting. Sporting events can be postponed, changed, or cancelled for many reasons. Weather conditions, player injuries, venue changes, and so on can generate alterations in a sporting event that can affect the betting odds on the event. The cross-validating includes an automatic website lookup. Information on a sporting event can be accessed via one or more websites, including websites other than the digital betting platforms. The information from the additional websites can be parsed and used to confirm the information contained on the digital betting sites, including the time, date, and location of the event, and so on. The cross-validating confirms that the sporting event is active. As the sporting event is confirmed as active, the betting odds information from the one or more digital betting platforms can be parsed and analyzed for odds opportunities. The trigger event can include a fixed time cadence, including one or more of every six hours, every day, and every week. The refreshing of the odds information from the one or more digital betting platforms on a fixed time cadence allows changes in the various betting platform odds to be analyzed and new odds opportunities to be posted.

The system 800 includes aggregating and generating components 840. The aggregating and generating components 840 can include functions and instructions for aggregating data from the at least one of the one or more betting odds opportunities, wherein the data enables generating a human-readable online article. In embodiments, the data from the one or more digital betting platforms is accessed, parsed, and categorized. Information from two or more digital betting platforms related to the same sporting events can be aggregated. The data from each of the one or more betting platforms can be stated in a like manner so that the similarities and differences between odds offered on the same sporting events by different betting platforms can be viewed and analyzed by bettors. The aggregated data can be used to generate human-readable online articles. In embodiments, the generating is based on one or more templates. A template is a computer document file that can receive data element input, such as text, pictures, widgets, and so on, from a separate data file. The data elements from the input data file are combined with text and graphics elements included in the template file. The input data elements are placed into designated placeholder positions within the template file and combined with the text and graphics data embedded in the template file to produce a separate document file. The separate document file comprises a human-readable article, combining the aggregated data from the one or more digital betting platforms with text and graphics included in the template file. The template can be designed to generate a human-readable article in a format suitable for online access. The templates are customizable, wherein the customizing is based on the one or more betting opportunities. A template can include optional phrases, sentences, and paragraphs that are rendered upon conditions that arise from the data elements included in the input data file. The customizing includes data obtained from sources different from the one or more digital betting platforms. The customizing includes sporting event game variables and league variables. The customizing further comprises categorizing the online article based on the sporting event game variables and the league variables.

In embodiments, the generating further comprises refreshing the online article that was published. The refreshing rate is determined by a variable contained in the template. The refreshing rate can be varied based on the time proximity of the related sports event, the number of bets received for the sports event, and so on. As the date and time of a particular sports event draws nearer, the refreshing rate for the related online articles can be made more or less frequently as necessary.

In embodiments, the one or more templates enable seeding a machine learning model. The machine learning model can be used to generate human-like text from the given input, using a combination of machine learning algorithms and natural language processing techniques. The model algorithms can be trained with a large body of text, including sports books, sports magazine and newspaper articles, and other text sources including sports booking platform articles. The text generation model algorithms can then be used to generate text from data input from similar sources, such as the digital betting platform information. As the text generation model takes in more input over time, the ability to generate human-readable text articles improves. In some embodiments, the machine learning model can replace one or more templates.

The system 800 includes a selecting component 850. The selecting component 850 can include functions and instructions for selecting one or more dynamic article features related to the at least one of the one or more betting odds opportunities. In embodiments, the dynamic article features include images related to a sporting event described by the one or more betting odds opportunities. The dynamic article features include embedded widgets related to a sporting event described by the one or more betting odds opportunities. The dynamic article features include categories related to a sporting event described by the one or more betting odds opportunities. As individual sporting events are identified and the betting odds and other information related to the sporting events are parsed, matched, and aggregated, additional features can be added to the human-readable online articles being generated. Images related to a specific sporting event, widgets directing bettors to related articles or team websites, hypertext links to league websites, and so on can be added into the human-readable online articles. Widgets representing the team logos can be included in the online article that can start a separate browser page with the team website, or hyperlinks to the league website can be embedded in the online article as they are related to a sporting event described by the one or more betting odds opportunities. The resulting document, including all the relevant dynamic features can be published as a complete human-readable online article.

The system 800 includes a publishing component 860. The publishing component 860 can include functions and instructions for publishing the online article, wherein the online article includes the at least one of the one or more betting odds opportunities and the one or more dynamic article features. In embodiments, the one or more betting odds opportunities can be identified and generated for one or more sports events at the same time. This can result in one or more online articles being generated and prepared to publish at the same time. Batch publishing of the human-readable online articles can allow control over the number and timing of generated online articles being published at one time. In embodiments, a random number generator can be used to initiate the publishing of the online articles. The initiating of the publishing using a random number generator facilitates batch publishing of a plurality of online articles at the same time. The batch publishing enables search engine optimization (SEO). Search engine optimization is a set of website practices that is designed to improve a site's ranking in the non-paid section of search results from Internet search engines. A significant percentage of all traffic on the Internet comes from search engines. Controlling the rate at which new or refreshed online articles are added to a website allows time for the various search engines to rank the website without flagging the added online articles as spam.

The system 800 can include a computer program product embodied in a non-transitory computer readable medium for content generation, the computer program product comprising code which causes one or more processors to perform operations of: accessing one or more digital betting platforms, wherein the one or more digital betting platforms each provide one or more betting odds opportunities for an online user, and wherein the one or more betting odds opportunities include sporting events; detecting a content trigger event, wherein the content trigger event corresponds to at least one of the one or more betting odds opportunities; aggregating data from the at least one of the one or more betting odds opportunities, wherein the data enables generating a human-readable online article; selecting one or more dynamic article features related to the at least one of the one or more betting odds opportunities; and publishing the online article, wherein the online article includes the at least one of the one or more betting odds opportunities and the one or more dynamic article features.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams, infographics, and flow diagrams show functions, steps, or groups of steps of the methods, apparatus, systems, computer program products and/or computer-implemented methods. Any and all such functions—generally referred to herein as a “circuit,”“module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for content generation comprising:
accessing one or more digital betting platforms, wherein the one or more digital betting platforms each provide one or more betting odds opportunities for an online user, and wherein the one or more betting odds opportunities include sporting events;
detecting a content trigger event, wherein the content trigger event corresponds to at least one of the one or more betting odds opportunities;
aggregating data from the at least one of the one or more betting odds opportunities, wherein the data enables generating a human-readable online article;
selecting one or more dynamic article features related to the at least one of the one or more betting odds opportunities; and
publishing the online article, wherein the online article includes the at least one of the one or more betting odds opportunities and the one or more dynamic article features.

2. The method of claim 1 further comprising cross-validating a sporting event, based on the detecting.

3. The method of claim 2 wherein the cross-validating includes an automatic website lookup.

4. The method of claim 2 wherein the cross-validating confirms that the sporting event is active.

5. The method of claim 1 further comprising using a random number generator to initiate the publishing.

6. The method of claim 5 wherein the initiating the publishing facilitates batch publishing of a plurality of online articles at the same time.

7. The method of claim 6 wherein the batch publishing enables search engine optimization.

8. The method of claim 1 wherein the generating is based on one or more templates.

9. The method of claim 8 wherein the templates are customizable.

10. The method of claim 9 wherein the customizing is based on the one or more betting odds opportunities.

11. The method of claim 9 wherein the customizing includes data obtained from sources different from the one or more digital betting platforms.

12. The method of claim 9 wherein the customizing includes sporting event game variables and league variables.

13. The method of claim 12 further comprising categorizing the online article based on the sporting event game variables and the league variables.

14. The method of claim 8 further comprising refreshing the online article that was published.

15. The method of claim 14 wherein a rate of refreshing is determined by a variable contained in the template.

16. The method of claim 8 wherein the one or more templates enable seeding a machine learning model.

17. The method of claim 16 wherein the machine learning model replaces the one or more templates.

18. The method of claim 1 wherein the dynamic article features include images related to a sporting event described by the one or more betting odds opportunities.

19. The method of claim 1 wherein the dynamic article features include embedded widgets related to a sporting event described by the one or more betting odds opportunities.

20. The method of claim 1 wherein the dynamic article features include categories related to a sporting event described by the one or more betting odds opportunities.

21. The method of claim 1 wherein the content trigger event includes first-time posting of odds for a sporting event by the one or more digital betting platforms.

22. The method of claim 1 wherein the trigger event includes a fixed time cadence.

23. The method of claim 22 wherein the fixed time cadence includes one or more of every six hours, every day, and every week.

24. The method of claim 1 wherein the one or more digital betting platforms comprises sportsbooks.

25. A computer program product embodied in a non-transitory computer readable medium for content generation, the computer program product comprising code which causes one or more processors to perform operations of:
accessing one or more digital betting platforms, wherein the one or more digital betting platforms each provide one or more betting odds opportunities for an online user, and wherein the one or more betting odds opportunities include sporting events;
detecting a content trigger event, wherein the content trigger event corresponds to at least one of the one or more betting odds opportunities;
aggregating data from the at least one of the one or more betting odds opportunities, wherein the data enables generating a human-readable online article;
selecting one or more dynamic article features related to the at least one of the one or more betting odds opportunities; and
publishing the online article, wherein the online article includes the at least one of the one or more betting odds opportunities and the one or more dynamic article features.

26. A computer system for content generation comprising:
a memory which stores instructions;
one or more processors coupled to the memory wherein the one or more processors, when executing the instructions which are stored, are configured to:
access one or more digital betting platforms, wherein the one or more digital betting platforms each provide one or more betting odds opportunities for an online user, and wherein the one or more betting odds opportunities include sporting events;
detect a content trigger event, wherein the content trigger event corresponds to at least one of the one or more betting odds opportunities;
aggregate data from the at least one of the one or more betting odds opportunities, wherein the data enables generating a human-readable online article;
select one or more dynamic article features related to the at least one of the one or more betting odds opportunities; and
publish the online article, wherein the online article includes the at least one of the one or more betting odds opportunities and the one or more dynamic article features.
